(19) United States
(12) Patent Application Publication
(10) Pub. No.: US 2003/0116537 A1
(43) Pub. Date: Jun. 26, 2003

(54) Fuel tank for a motor vehicle

(76) Inventors: Knut Meyer, Essen (DE); Frank Reiter, Bad Soden (DE); Holger Schier, Essen (DE); Heinz-Werner Trappmann, Dortmund (DE); Hartwig Wanka, Dusseldorf (DE)

Correspondence Address: Morrison & Foerster LLP, Suite 300, 1650 Tysons Boulevard, McLean, VA, 22102, US

(21) Appl. No.: 10/277,163

(22) Filed: Oct. 22, 2002

(30) Foreign Application Priority Data
Oct. 23, 2001 (DE) 10152131.6

(51) Int. Cl. B23K 31/00

(52) U.S. Cl. 219/78.16; 228/174

(57) ABSTRACT

In a fuel tank for a motor vehicle having shells tightly connected together, positioning aids are arranged in proximity to a weld. The positioning aids permit an accurately fitting assembly of the shells prior to welding. This makes the fuel tank particularly inexpensive to manufacture.

### CLAIM FOR PRIORITY

This application claims priority to Application No. 10152131.6 which was filed in the German language on Oct. 23, 2001.

### TECHNICAL FIELD OF THE INVENTION

The invention relates to a fuel tank for a motor vehicle having at least two shells materially fused together.

### BACKGROUND OF THE INVENTION

Fuel tanks are frequently used in present-day motor vehicles and are known in practice. The shells of the known fuel tank are made of metal by the deep-drawing process, for example, and in each case have a peripheral flange. The fuel tank is tightly welded at the peripheral flanges of two opposite shells. The shells, however, have production tolerances, which result in the flanges being inaccurately positioned in relation to one another when assembling the shells prior to welding.

In order to ensure a reliable welding process, the misalignment must not exceed a defined amount. In practice, improvised remedies are sought in order to bring the misalignment to the required dimension by machining, for example. This method is costly, however, and metal particles can adversely affect the weld quality.

### SUMMARY OF THE INVENTION

The discloses a fuel tank designed so that it can be manufactured to a high quality standard as inexpensively as possible.

According to one embodiment of the invention, positioning aids are arranged on the areas of the shells which are to be materially fused together.

When assembling the shells, this arrangement compensates for any tolerances through slight bending of areas of the shells adjoining the positioning aids. The areas to be welded together can therefore be made to overlap precisely by means of the positioning aids. Arrangement of the positioning aids on the areas to be welded together has the advantage that tolerances manageable in the welding process can now be achieved between the positioning aids and the areas to be welded together. In the invention, after joining the shells no machining of the shells is necessary. The fuel tank according to the invention can therefore be produced to a high quality at low cost. A further advantage of this arrangement is that the positioning aids are capable of absorbing forces occurring in the plane of the areas which are to be welded together. This relieves the materially fused connection of the shells of any shear forces.

According to another embodiment of the invention, the cost of welding and of producing the positioning aids can be kept especially low if the positioning aids are arranged on flanges of the shells, which bear on one another and are intended for welding.

The positioning aids, for example, may have bolts that are to be passed through recesses in the shells. In order to further reduce the costs of manufacturing the fuel tank according to the invention, however, it is advantageous if the positioning aids are integrally formed with the shells. The shells are fixed together when they are assembled prior to welding.

According to another embodiment of the invention, if the positioning aids have essentially the same material thickness as adjoining areas of the shells, the positioning aids can be produced by simple stamping of the shells during their production by the deep-drawing process. This helps to further reduce the production costs of the fuel tank according to the invention.

The positioning aids could be formed, for example, as a peripheral flange on one of the shells and could laterally grip around the flange on the other shell. However, the shells of the fuel tank according to the invention are as easily welded as in the case of the known fuel tank if the positioning aids are designed to project from one of the shells and the positioning aids on the other shell are of complementary design.

According to still another embodiment of the invention, the positioning aids can be designed with a particular simplicity if the positioning aids take the form of a peripheral bead.

According to yet another embodiment of the invention, assembly of the shells prior to welding is especially facilitated if the positioning aids take the form of individual lugs.

### BRIEF DESCRIPTION OF THE DRAWINGS

The invention illustrates numerous embodiments. In order to further illustrate its basic principle, two such embodiments are shown in the drawings and are described below. In the drawings:

FIG. 1 shows a diagram of a partial area of a fuel tank according to the invention having two shells welded together.

FIG. 2 shows a partial area of two shells of a further embodiment of the fuel tank according to the invention that have been welded together.

### DETAILED DESCRIPTION OF THE PREFERRED EMBODIMENTS

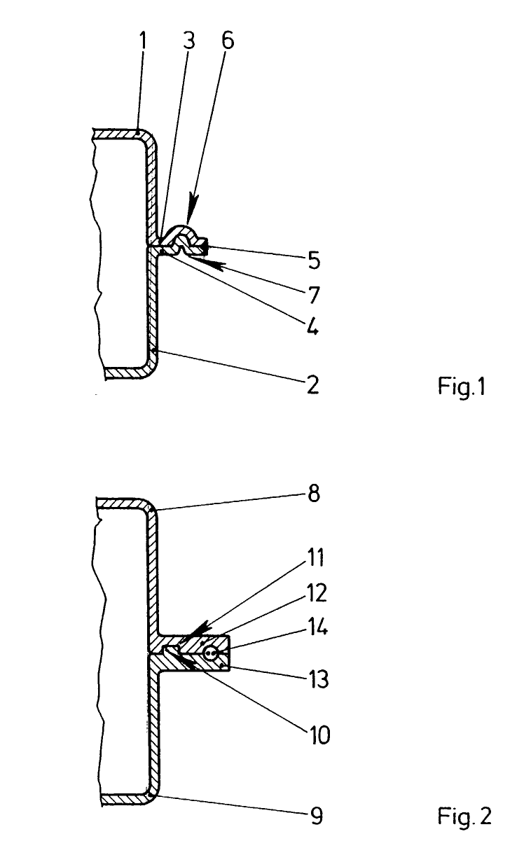

FIG. 1 shows a sectional representation through a lateral area of a fuel tank having two shells 1, 2. The shells 1, 2 are made of sheet metal by the deep-drawing process and each have a flange 3, 4 on their adjoining areas. At the edge of the flanges 3, 4 the shells 1, 2 are tightly connected to one another by a weld 5. In the middle area of the flanges 3, 4, the shells 1, 2 each have positioning aids 6, 7 corresponding to one another. The positioning aids 7 of one shell 2 take the form of a peripheral, protruding bead. The positioning aids 6 of the other shell 1 take the form of a concavity formed to correspond to the peripheral bead. The positioning aids 6, 7 permit an accurately fitting assembly of the two shells 1, 2 prior to welding. In the welded state of the fuel tank, the positioning aids 6, 7 furthermore support forces acting on the shells 1, 2 in the plane of the flanges 3, 4.

FIG. 2 in a sectional representation likewise shows a lateral area of a further embodiment of the fuel tank having two shells 8, 9. The shells 8, 9 are made of injection molded plastic. One of the shells 9 has positioning aids 10 in the form of individual lugs, while the other shell 8 has positioning aids 11 in the form of recesses designed to correspond to the lugs. A heating resistance wire 14 is arranged close to the outer edge of the flanges 12, 13 of the shells 8, 9 carrying the positioning aids. The shells 8, 9 are tightly welded by passing a current through the heating resistance wire 14, fusing the flanges 12, 13. In the process the flanges 12, 13 are tightly and materially fused together.

What is claimed is:

1. A fuel tank for a motor vehicle having at least two shells materially fused together, wherein positioning aids are arranged on areas of the at least two shells to be materially fused together.

2. The fuel tank as claimed in claim 1, wherein the positioning aids are arranged on flanges of the at least two shells that adjoin one another and are intended for welding.

3. The fuel tank as claimed in claim 1, wherein the positioning aids are integrally formed with the at least two shells.

4. The fuel tank as claimed in claim 1, wherein the positioning aids have substantially equivalent material thickness as adjoining areas of the at least two shells.

5. The fuel tank as claimed claim 1, wherein the positioning aids on one of the at least two shells are designed to project and on another of the at least two shells are designed to complement projecting positioning aids.

6. The fuel tank as claimed in claim 1, wherein the positioning aids are configured as a peripheral bead.

7. The fuel tank as claimed in claim 1, wherein the positioning aids are configured as individual lugs.
